(19) United States
(12) Patent Application Publication
(10) Pub. No.: US 2005/0048904 A1
(43) Pub. Date: Mar. 3, 2005

(54) Vehicle air duct assembly of an integrated beam structure

(75) Inventor: Jong-Won Lee, Seoul (KR)

Correspondence Address: GREENBLUM & BERNSTEIN, P.L.C., 1950 ROLAND CLARKE PLACE, RESTON, VA, 20191, US

(73) Assignee: HYUNDAI MOBIS, Seoul (KR)

(21) Appl. No.: 10/682,974

(22) Filed: Oct. 14, 2003

(30) Foreign Application Priority Data
Aug. 11, 2003 (KR) 2003-55384

(51) Int. Cl. B60S 1/54

(52) U.S. Cl. 454/127

(57) ABSTRACT

A vehicle air duct assembly of an integrated beam structure includes a front beam member which is formed with an air vent duct for guiding air for the air conditioning of an automobile, a cowl cross bar for reinforcing the rigidity of the vehicle body and brackets for attaching a plurality of electrical equipment parts including an air bag; and a rear beam member which is coupled to the rear side of the front beam member and guides parts of air flowing through the air vent duct toward a front window glass of the automobile. According to the air duct, the number of parts is reduced, thus the manufacturing process is simplified, and a mixed material of steel and thermoplastic resin is used, thus the overall strength is increased and the weight is reduced.

### RELATED APPLICATION

The present disclosure relates to subject matter contained in Korean application No.2003-55384, filed on Aug. 11, 2003, which is herein expressly incorporated by reference its entirety.

### BACKGROUND OF THE INVENTION

1. Field of the Invention

The present invention relates to a vehicle air duct assembly of an integrated beam structure, and more particularly, to a vehicle air duct assembly of an integrated beam structure which can reduce the number of parts, the weight, and make attaching or detaching easier according to whether there is a need for parts for alleviating the impact from an accident, reducing the cost by forming the air duct and a cowl cross bar of a thermoplastic resin and forming the parts coupled to a steel material.

2. Description of the Related Art

Generally, an apparatus for mounting electric parts of an automobile and an apparatus for guiding air for the ventilation, cooling, and heating of an automobile, are produced of parts, and then assembled into a single unit through an assembly process.

As shown in FIG. 1, an air vent duct 1 for supplying ventilated, cooled, or heated air into the interior of an automobile is formed with a plurality of channels for guiding the air to the center and sides of the vehicle.

At the rear of the air vent duct 1, a defroster duct 3 is installed for executing a defrosting function by guiding parts of the air flowing through the air vent duct 1 toward the front window glass of the automobile.

Below the air vent duct 1, a cowl cross bar 5 of a bar shape is installed for supporting various kinds of bracket parts such as the air vent duct 1 as well as reinforcing the vehicle body.

At the opposite ends of the cowl cross bar 5, cowl cross mounting brackets 7 and 9 are coupled respectively, and, by these mounting brackets 7 and 9, the cowl cross bar 5 can be fastened to the vehicle body.

In addition, to the cowl cross bar 5, coupled are an electric equipment part mounting bracket 11 for mounting electric equipment parts, such as a junction box, and a steering shaft mounting bracket 13 for fixing the steering column of a vehicle steering system.

Also, to the area near the driver's seat and the passenger's seat of the cowl cross bar 5, a knee bolster mounting bracket 15 is coupled. The knee bolster mounting bracket 15 is used for mounting a knee bolster (not shown) for protecting the knees of the driver and passenger sitting in the front seats.

And, to the position corresponding to the passenger's seat of the cowl cross bar 5, an airbag mounting bracket 17 is coupled for mounting an passenger airbag.

A center support 20 includes a pair of support brackets 21 arranged at the left and right with a predetermined interval and an audio mounting bracket 23 arranged between the support brackets 21 for mounting au audio system of the vehicle. The upper end of the center support 20 is connected to the center of the cowl cross bar 5 and the lower end thereof is connected to a floor panel forming the bottom surface of the automobile.

In a conventional air vent duct 1, upon assembly, parts including the air vent duct 1, the electric equipment part mounting bracket 11, the steering shaft mounting bracket 13 and the center support 20 are coupled to the cowl cross bar 5.

That is to say, the conventional air vent duct 1 is of a structure in which a plurality of parts is coupled to the cowl cross bar 5, thus the rigidity and durability of the product are deteriorated and there is a risk of noise generation when operating the vehicle due to the poor coupling between the parts.

Moreover, since each of the parts is manufactured individually, there is an increase in logistics cost and increase of production cost.

To solve such problems, there has been recently devised a method for producing various parts, such as a cowl cross bar, an air duct and a center support, integrally from a thermoplastic resin.

However, according to this type of air duct structure, since the parts are made only of a thermoplastic resin of a relatively small rigidity, the rigidity of the product is lower. Further, in the case where there are optional parts which can be attached and detached, costs are increased in order to provide materials consistent with the specification of each product.

### SUMMARY OF THE INVENTION

The present invention is designed in consideration of the problems of the prior art, and therefore it is an object of the present invention to provide a vehicle air duct assembly of an integrally integrated beam structure which can reduce the amount of assembling needed and reduce logistics and production costs by simplifying the coupling structure of an air vent duct, a cowl cross bar and various bracket parts.

It is another object of the present invention to provide the vehicle air duct assembly of an integrated beam structure which can minimize noise generated from coupling regions between parts by reducing the total number of the parts.

It is still another object of the present invention to provide a vehicle air duct assembly of an integrated beam structure which can increase the structural strength, reduce the overall weight and allow parts to be easily (de)mountable according to the specification of each individual product by manufacturing the members under stress and the other members from different materials in an integrated beam structure where various parts are coupled.

To achieve the above object, there is provided a vehicle air duct assembly of an integrated beam structure, comprising: a front beam member which is integrated with an air vent duct for guiding air for the air conditioning of an automobile, a cowl cross bar for reinforcing the rigidity of the vehicle body and brackets for attaching a plurality of electric equipment parts including an air bag; and a rear beam member which is coupled to the rear side of the front beam member and guides parts of air flowing through the air vent duct toward the front of the automobile.

In the air duct, according to the present invention, the number of parts is reduced, thus a manufacturing process is simplified, and a material of steel and thermoplastic resin is used, thus the overall strength is increased and the weight is reduced.

### BRIEF DESCRIPTION OF THE DRAWINGS

Other objects and aspects of the present invention will become apparent from the following description of embodiments with reference to the accompanying drawings in which:

FIG. 1 is an exploded perspective view showing a coupled state of electrical equipment parts including a conventional air duct;

FIG. 2 is a perspective view showing a vehicle air duct assembly of an integrated beam structure according to an embodiment of the present invention;

FIG. 3 is an exploded perspective view of FIG. 2;

FIG. 4 is a perspective view showing a front beam member according to the embodiment of the present invention;

FIG. 5 is a perspective view showing a center support according to the embodiment of the present invention; and

FIG. 6 is a perspective view showing a buffer member according to the present invention.

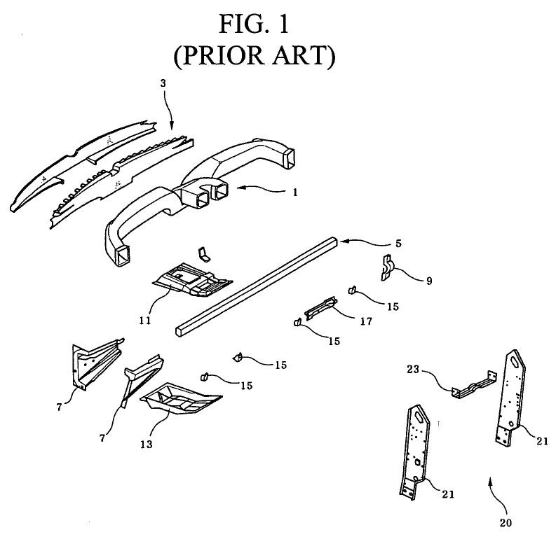

### DESCRIPTION OF THE PREFERRED EMBODIMENT

Hereinafter, an airduct assembly according to a preferred embodiment of the present invention will be described in more detail referring to the drawings.

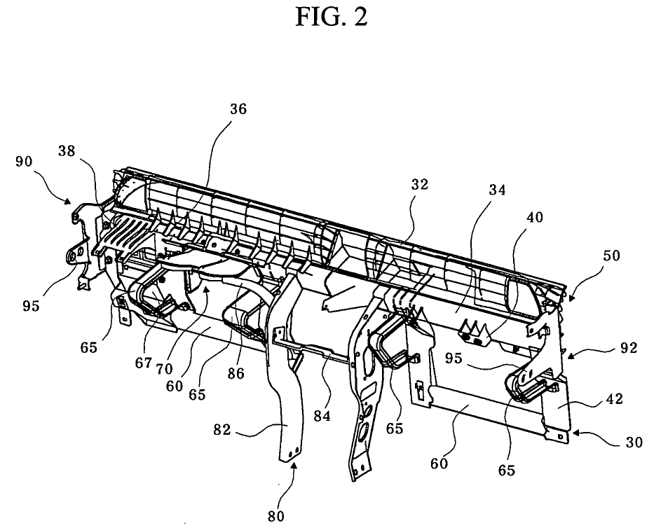

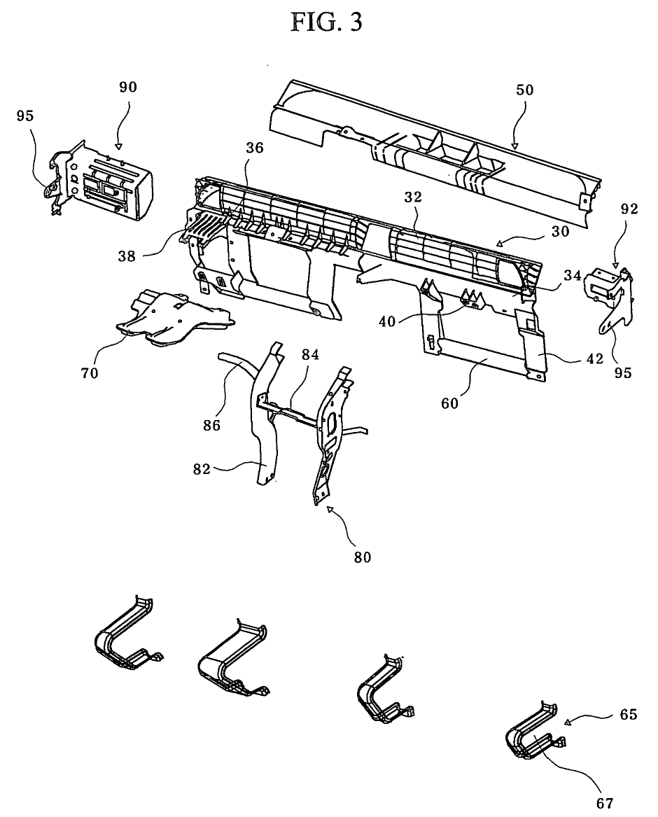

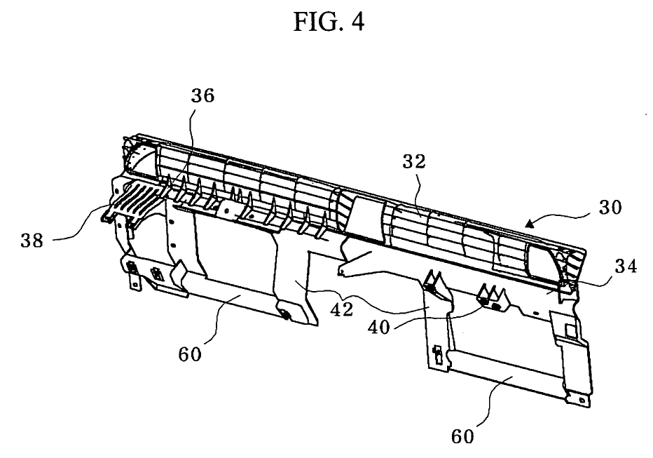

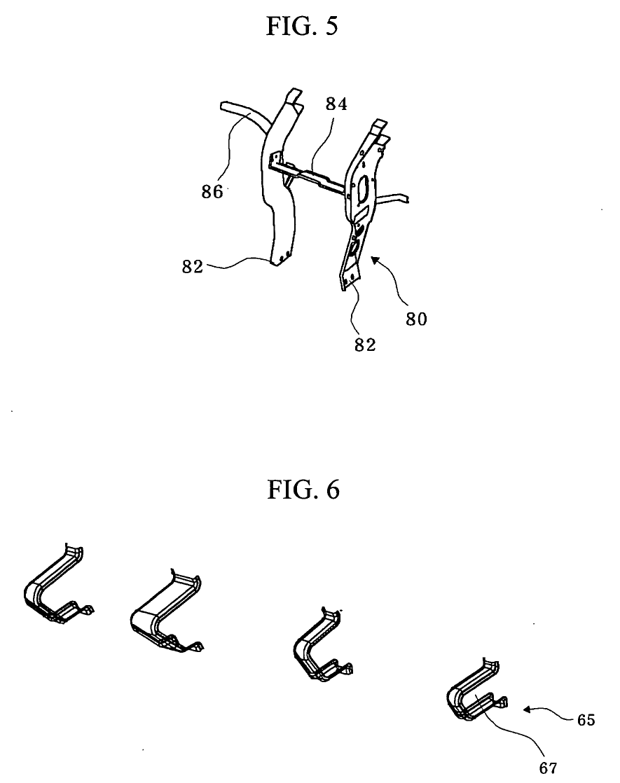

FIG. 2 is a perspective view showing a vehicle air duct assembly of an integrated beam structure according to an embodiment of the present invention. FIG. 3 is an exploded perspective view of FIG. 2. FIG. 4 is a perspective view showing a front beam member according to the embodiment of the present invention. FIG. 5 is a perspective view showing a center support according to the embodiment of the present invention. FIG. 6 is a perspective view showing a buffer member according to the present invention.

As shown in FIGS. 2 to 6, a vehicle air duct assembly of an integrated beam structure according to the embodiment of the present invention includes: a front beam member 30 having an air vent duct 32 and a cowl cross bar 34 formed integral with each other; and a rear beam member 50 of a duct coupled to the rear side of the front beam member 30 for guiding the air flowing through the air vent duct 32 toward the direction of a front window glass.

In the front beam member 30, as shown in the drawings, the air vent duct 32 is formed at an upper side for guiding a ventilated, heated or cooled air, and the cowl cross bar 34 is integrally formed on a lower side of the air vent duct 32 for reinforcing the rigidity of the vehicle.

Between the cowl cross bar 34 and the air vent duct 32, a reinforcing rib 36 is formed to couple the air vent duct 32 and the cowl cross bar 34 firmly coupled together, thereby to improve the durability.

At the driver's seat portion of the cowl cross bar 34, an electric equipment mounting bracket 38 is coupled to allow electrical parts such as a junction box to be attached to the electric equipment part mounting bracket 38.

At the passenger's seat portion of the cowl cross bar 34, an airbag mounting bracket 40 for attaching an air bag projects from the cowl cross bar 34. Besides, a bracket for mounting various parts is integrated with the front beam member 30.

A plurality of support members 42 extending downward from the cowl cross bar 34 serves to support the front beam member 30 and also serves to support the lower panels of the driver's seat and passenger's seat.

The front beam member 30 and rear beam member 50 described above are made of a thermoplastic resin, which is easily moldable and has a high rigidity, made by injection molding. In another embodiment of the present invention, the front beam member 30 and the rear beam member 50 may be injected into a molding.

In the front beam member 30, energy absorption portions 60 made of a steel material and having a bar shape are installed at lower sides of the support members 42.

The energy absorption portions 60 are installed at the regions corresponding to the knee portions of the driver's seat and passenger's seat thereby alleviating the impact on the knees of front seat passengers in an accident.

Buffer members 65 alleviate an impact applied to the passengers in an accident along with the energy absorption portions 60. One end is fixed to the cowl cross bar 34 and the other end thereof is fixed to the support member 42.

The buffer members 65 are formed in a beam shape which project toward the front seats and have inside buffer space portions 67 which are curved. They are installed at the front beam member 30 corresponding to the driver's seat and passenger's seat.

In the event of an accident, an impact applied to the chest region of the passengers is alleviated by the buffer members 65 while an impact applied to the knees of the passengers is alleviated by the energy absorption portions 60.

If the impact force applied to the passenger is absorbed by the buffer members 65, the energy absorption portions 60 also serves as a supporting portion.

In the front beam member 30, a steering shaft mounting portion 70 is installed at the region for mounting the steering wheel of the driver's seat to support the steering column of a vehicle steering system.

Also, the center support 80, where the upper end is connected to the center portion of the cowl cross bar 34 of the front beam member 30 and whose the opposite end is connected to the floor panel of the automobile, includes a pair of support brackets 82 and an audio mounting bracket 84 for connecting the support brackets 82 and mounting an audio system.

A reinforcing bar 86 extending from one side of the support bracket 82 serves to reinforce the rigidity of the steering shaft mounting portion 70, which is generally under heavy stress, by connecting to one side of the steering shaft mounting portion 70.

At the left and right sides of the front beam member 30 where the above-described members are coupled, a first fixing bracket 90 and a second fixing bracket 92 are installed. One side of the first fixing bracket 90 and second fixing bracket 92 are fixed to the front beam member 30, and a jig hole 95 is formed on the other side.

The jig hole 95 functions to be held in position by a jig in a feeding job for an assembly process of the beam structure integrated with the air duct according to the embodiment of the present invention.

In the vehicle air duct of the integrated beam structure according to the embodiment of the present invention, the front beam member 30 and the rear beam member 50 are formed of a thermoplastic resin material, and the energy absorption portions 60, the steering shaft mounting portion 70, the center support 80, the buffer members 65, the first fixing bracket 90 and the second fixing bracket 92, which are coupled to the front and rear beam members 30 and 50, are formed of a steel material.

The portions under great stress are made of steel, while the other portions are made of a thermoplastic resin, thereby reducing the overall weight along with an increase in the structural rigidity.

The assembling process and operation of the vehicle air duct assembly for the integrally integrated beam structure according to the embodiment of the present invention will be described.

The front beam member 30 and the rear beam member 50 are made by an injection molding, then the rear beam member 50 is fixed to the rear surface of the front beam member 30 by vibration fusion.

Also, the energy absorption portions 60 are fixedly installed to the lower sides of the support members 42 corresponding to the driver's seat and the passenger's seat, and the buffer members 65 with the buffer space portions 67 are fixedly installed to the front surface of the front beam member 30.

The buffer members 65 according to the embodiment of the present invention are installed in such a manner that both ends can be in contact with the cowl cross bar 34 and the support members 42 respectively.

The steering shaft mounting portion 70 is fixed to the cowl cross bar 34, and the center support 80 is installed in such a manner that the upper ends of the support brackets are fixed to the center portion of the cowl cross bar 34 and the lower ends thereof are fixed to the floor of the vehicle.

The reinforcing bar 86 extending from the support bracket 82 of the center support 80 can increase the rigidity of the steering shaft mounting portion 70 by being connected and fixed to one side of the steering shaft mounting portion 70.

At the left and right sides of the front beam member 30, the first fixing bracket 90 and the second fixing bracket 92 are mounted for providing the jig hole 95 required for feeding the front beam member 30.

According to the present invention, the assembling process is reduced by integrating the cowl cross bar 34 and the air vent duct 32, including various brackets, with the production and logistics costs of the parts reduced with a decrease in the number of control parts, thereby to reducing manufacturing and production costs.

In addition, in the integrated beam structure and the air duct, the portions under stress are made of a steel material and the other portions are made of a thermoplastic resin, thereby increasing the structural rigidity and reducing the overall weight.

Furthermore, the energy absorption portions 60 and the buffer members 65 to be mounted to the front beam member 30 are easily mounted as needed, thus products can be produced individually, preventing additional manufacturing costs.

Moreover, many of the parts are integrally formed, thus defective factors such as noise generation caused by a poor coupling between the parts is reduced, thereby improving the product's durability and reliability.

As described above, according to the vehicle air duct assembly of the integrally integrated beam structure of this invention, various bracket parts including the air vent duct are formed with the cowl cross bar, thus the assembling process is reduced, the productivity is improved and the number of parts is reduced, thereby reducing logistics and production costs.

In addition, the number of coupled parts is reduced compared to the conventional art, thus defective factors such as noise generation caused by a poor coupled state between parts are reduced, increasing rigidity and improving the durability and reliability.

Further, the portions under stress are made of steel and the other portions are made of a thermoplastic resin, thereby increasing the structural rigidity and reducing the overall weight.

Moreover, the energy absorption portions and the buffer members, which are to be mounted to the front beam member, are easily mounted as needed, thereby preventing an increase in manufacturing costs.

1. A vehicle air duct assembly of an integrally integrated beam structure, comprising:
a front beam member which is formed integral with an air vent duct for guiding air for the air conditioning of an automobile, a cowl cross bar for reinforcing the rigidity of the vehicle body and brackets for attaching a plurality of electrical equipment parts including an air bag; and
a rear beam member which is coupled to the rear side of the front beam member and guides air flowing through the air vent duct toward a front window glass of the automobile.

2. The vehicle air duct assembly of claim 1, wherein the front beam member further comprises:
a steering shaft mounting portion which is mounted outward from the front beam member for fixedly supporting a vehicle steering system; and
a center support which is provided at one side with a reinforcing bar to supporting side of the steering shaft mounting portion and whose the upper end is connected to the front beam member and the other end is connected to the floor panel of the vehicle for mounting electrical equipment parts including an audio system.

3. The vehicle air duct assembly of claim 1, wherein the front beam member further comprises: energy absorption portions in a bar shape, which are mounted to the position corresponding to the knee portions of the driver's seat and the passenger's seat in a lengthwise direction along the front beam member.

4. The vehicle air duct assembly of claim 1, wherein the front beam member further comprises: buffer members which are projected toward the driver's seat and the passenger's seat of the automobile, have inside buffer space portions formed, and are installed at the regions corresponding to the driver's seat and passenger's seat in the front beam member.

5. The vehicle air duct assembly of claim 1, wherein, at the front surface of the front beam member, an airbag mounting bracket for mounting an airbag of the passenger's seat and an electrical equipment part mounting bracket for mounting electrical equipment parts are installed on sides of the cowl cross bar.

6. The vehicle air duct assembly of claim 1, wherein the front beam member and the rear beam member are formed of a thermoplastic resin material and the remaining members conforming to the front beam member are formed of a steel material.

7. The vehicle air duct assembly of claim 2, wherein the front beam member and the rear beam member are formed of a thermoplastic resin material and the remaining members conforming to the front beam member are formed of a steel material.

8. The vehicle air duct assembly of claim 3, wherein the front beam member and the rear beam member are formed of a thermoplastic resin material and the remaining members conforming to the front beam member are formed of a steel material.

9. The vehicle air duct assembly of claim 4, wherein the front beam member and the rear beam member are formed of a thermoplastic resin material and the remaining members conforming to the front beam member are formed of a steel material.

10. The vehicle air duct assembly of claim 5, wherein the front beam member and the rear beam member are formed of a thermoplastic resin material and the remaining members conforming to the front beam member are formed of a steel material.
